(19) United States
(12) Patent Application Publication
(10) Pub. No.: US 2006/0292433 A1
(43) Pub. Date: Dec. 28, 2006

(54) Fuel cell and fuel cell stack

(75) Inventor: Tetsuya Ogawa, Wako-shi (JP)

Correspondence Address: LAHIVE & COCKFIELD, LLP, ONE POST OFFICE SQUARE, BOSTON, MA, 02109-2127, US

(73) Assignee: Honda Motor Co., Ltd., Tokyo (JP)

(21) Appl. No.: 11/473,668

(22) Filed: Jun. 23, 2006

(30) Foreign Application Priority Data
Jun. 24, 2005 (JP) 2005-185545

(51) Int. Cl. H01M 8/02

(52) U.S. Cl. 429/38; 429/39

(57) ABSTRACT

A fuel cell includes electrolyte electrode assemblies and a pair of separators sandwiching the electrolyte electrode assemblies. A fuel gas channel is provided along one surface of the separator, and an oxygen-containing gas channel is provided along the other surface of the separator. A groove connected to a fuel gas supply passage and a fuel gas inlet, is formed on the surface of the separator. Further, a channel lid member covers the groove to form a fuel gas supply channel.

### BACKGROUND OF THE INVENTION

1. Field of the Invention

The present invention relates to a fuel cell including an electrolyte electrode assembly and a pair of separators sandwiching the electrolyte electrode assembly. The electrolyte electrode assembly includes an anode, a cathode, and an electrolyte interposed between the anode and the cathode. Further, the present invention relates to a fuel cell stack formed by stacking a plurality of the fuel cells.

2. Description of the Related Art

Typically, a solid oxide fuel cell (SOFC) employs an electrolyte of ion-conductive solid oxide such as stabilized zirconia. The electrolyte is interposed between an anode and a cathode to form an electrolyte electrode assembly (unit cell). The electrolyte electrode assembly is interposed between separators (bipolar plates). In use, a predetermined number of the unit cells and the separators are stacked together to form a fuel cell stack.

As the fuel cell having the stack structure, for example, a fuel cell as disclosed in Japanese Laid-Open Patent Publication No. 2002-280021 is known. As shown in FIG. 24, in the fuel cell, a plurality of power generation cells 1 are arranged in the same horizontal surface, and the power generation cells 1 and the separators 2 are stacked alternately in the vertical direction. Each of the power generation cells 1 includes a fuel electrode layer 1b, an air electrode layer 1c, and a solid electrolyte layer 1a interposed between the fuel electrode layer 1b and the air electrode layer 1c. A porous fuel electrode current collector 3 is provided on the fuel electrode layer 1b, and a porous air electrode current collector 4 is provided on the air electrode layer 1c.

A plurality of fuel supply grooves 5a and a plurality of air supply grooves 6a are formed in the separator 2, at substantially the center in the thickness direction. The fuel supply grooves 5a and the air supply grooves 6a are not connected. Grooves 5b and grooves 6b are formed to be connected to the fuel supply grooves 5a and the air supply grooves 6a, respectively. Lids 5c are provided at the grooves 5b, and lids 6c are provided at the grooves 6b. The lid 5c has a hole 5d for supplying the fuel gas to the fuel electrode layer 1b to form a fuel supply channel 5, and the lid 6c has a hole 6d for supplying the air to the air electrode layer 1c to form an air supply channel 6.

In the conventional technique, the fuel supply grooves 5a and the air supply grooves 6a are formed in the separators 2, and the grooves 5b, 6b are connected to the fuel supply grooves 5a and the air supply grooves 6a to form the fuel supply channel 5 and the air supply channel 6 on both surface of the separator 2.

In the structure, the thickness of the separators 2 is large, and the overall size of the fuel cell formed by stacking the separators 2 and the power generation cells 1 is large. Further, the separators 2 have complicated structure, and the production cost of the separators 2 is high. Thus, the overall production cost of the fuel cell is considerably high.

### SUMMARY OF THE INVENTION

A main object of the present invention is to provide a fuel cell and a fuel cell stack having simple and compact structure in which a reactant gas is supplied uniformly to each electrolyte electrode assembly, and the desired power generation performance is achieved.

The present invention relates to a fuel cell including an electrolyte electrode assembly and a pair of separators sandwiching the electrolyte electrode assembly. The electrolyte electrode assembly includes an anode, a cathode, and an electrolyte interposed between the anode and the cathode. Each of the separators comprises a single plate.

The fuel cell comprises a fuel gas channel provided on one surface of the separator for supplying a fuel gas along an electrode surface of the anode, an oxygen-containing gas channel provided on the other surface of the separator for supplying an oxygen-containing gas along an electrode surface of the cathode, a groove formed on the one surface or on the other surface of the separator, and connected to a fuel gas supply unit and a fuel gas inlet for supplying the fuel gas into the fuel gas channel, and a channel lid member provided on the one surface or on the other surface of the separator to cover the groove for forming a fuel gas supply channel.

Further, preferably, protrusions forming the fuel gas channel are provided on one surface of the separator, and a deformable elastic channel unit forming the oxygen-containing gas channel and tightly contacting the cathode is provided on the other surface of the separator. Since the elastic channel unit is deformed elastically, the elastic channel unit tightly contacts the cathode. In the structure, the dimensional errors or distortions that occurred at the time of production in the electrolyte electrode assembly or in the separator can suitably be absorbed. The damage at the time of stacking the components of the fuel cell is prevented. Since the elastic channel unit and the cathode contact at many points, improvement in the performance of collecting electricity is achieved.

Further, preferably, when a load in the stacking direction of the electrolyte electrode assembly and the separators is applied to the fuel cell, the height of the channel lid member is smaller than the height of the protrusions or the elastic channel unit in the stacking direction. In the structure, the load in the stacking direction is not applied to the channel lid member, and the fuel gas supply channel is not deformed. The fuel gas is supplied to the anode suitably.

Further, preferably, the fuel cell further comprises an exhaust gas channel for discharging the fuel gas and the oxygen-containing gas consumed in the reaction in the electrolyte electrode assembly as an exhaust gas in the stacking direction of the electrolyte electrode assembly and the separators, the fuel gas supply unit for supplying the fuel gas before consumption in the stacking direction is provided hermetically inside the exhaust gas channel, and the fuel gas supply channel connects the fuel gas channel and the fuel gas supply unit, and is provided along the separator surface to intersect the exhaust gas channel extending in the stacking direction. In the structure, the fuel gas before consumption is heated beforehand by the heat of the exhaust gas. Thus, improvement in the heat efficiency is achieved.

Further, preferably, the exhaust gas channel is provided at the central region of the separators. In the structure, the separators can be heated radially from the center, and improvement in the heat efficiency is achieved.

Further, preferably, the fuel gas supply unit is provided hermetically at the center of the exhaust gas channel. The fuel cell is not consumed unnecessarily, while preventing the fuel gas and the exhaust gas from being mixed together. Thus, improvement in the heat efficiency is achieved.

Further, preferably, the fuel gas inlet is provided at the center of the electrolyte electrode assembly or at an upstream position deviated from the center of the electrolyte electrode assembly in the flow direction of the oxygen-containing gas. In the structure, the fuel gas supplied into the fuel gas inlet can be distributed radially from the center of the anode. Thus, the uniform reaction is achieved, and improvement in the fuel utilization ratio is achieved.

Further, preferably, the fuel cell further comprises an oxygen-containing gas supply unit for supplying the oxygen-containing gas before consumption from the outer circumference of the electrolyte electrode assembly to the oxygen-containing gas supply channel. In the structure, the exhaust gas is discharged smoothly toward the center of the separators.

Further, preferably, the fuel cell further comprises an exhaust gas channel for discharging the fuel gas and the oxygen-containing gas consumed in the reaction in the electrolyte electrode assembly as an exhaust gas in the stacking direction of the electrolyte electrode assembly and the separators, and an oxygen-containing gas supply unit for allowing the oxygen-containing gas before consumption to flow in the stacking direction to supply the oxygen-containing gas to the oxygen-containing gas channel. The fuel gas supply unit for supplying the fuel gas before consumption in the stacking direction is provided hermetically inside the oxygen-containing gas supply unit, and the fuel gas supply channel connects the fuel gas channel and the fuel gas supply unit, and is provided along the separator surface to intersect the oxygen-containing gas supply unit extending in the stacking direction. In the structure, the fuel gas before consumption can be heated by the oxygen-containing gas, and improvement in the heat efficiency is achieved.

Further, preferably, the exhaust gas channel is provided around the separators. In the structure, the exhaust gas is used as a heat-insulating layer. Therefore, heat radiation from the separator members can be prevented, and improvement in the heat efficiency is achieved.

Further, preferably, the fuel gas supply unit is provided hermetically at the center of the separators. In the structure, the fuel gas is not consumed unnecessarily, and improvement in the heat efficiency is achieved.

Further, preferably, the fuel cell further comprises an oxygen-containing gas supply unit for supplying the oxygen-containing gas before consumption from the inner circumferential surface of the electrolyte electrode assembly to the oxygen-containing gas supply channel. In the structure, the fuel gas before consumption is heated by the oxygen-containing gas, and improvement in the heat efficiency is achieved.

Further, preferably, an area where the elastic channel unit is provided is smaller than a power generation area of the anode. In the structure, even if the exhaust gas flows around to the anode of the electrolyte electrode assembly, the power generation area is not present in the outer circumferential edge of the cathode opposite to the outer circumferential edge of the anode. Thus, the loss in the collected electrical current is avoided, and the performance of collecting electricity is improved advantageously.

Further, preferably, the elastic channel unit is made of an electrically conductive metal mesh member. Thus, the structure is simplified economically.

Further, preferably, the protrusions are solid portions formed on one surface of the separator by etching. In the structure, the protrusions having the desired shape can be formed at the desired positions easily. Further, the protrusions are not deformed. Thus, the load is transmitted effectively, and improvement in the performance of collecting electricity is achieved.

Further, preferably, a plurality of electrolyte electrode assemblies are arranged along a virtual circle concentric with the separators. Thus, the fuel cell has compact structure, and the influence of heat distortion can be avoided.

In the present invention, the separator can be fabricated only by making the groove. Thus, the thickness of the separator is reduced effectively. In the fuel cell including the electrolyte electrode assembly and the pair of separators, the dimension in the stacking direction is reduced significantly, and the size of the fuel cell is reduced easily. Further, the structure of the separator is simplified greatly. The production cost of the separator is effectively reduced, and the fuel cell can be fabricated economically as a whole.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a partial cross sectional view showing a fuel cell system according to a first embodiment of the present invention;

FIG. 2 is a perspective view schematically showing a fuel cell stack of the fuel cell system;

FIG. 3 is an exploded perspective view schematically showing a fuel cell of the fuel cell stack;

FIG. 4 is a partial exploded perspective view showing gas flows in the fuel cell;

FIG. 5 is a front view showing a separator;

FIG. 6 is a cross sectional view schematically showing operation of the fuel cell;

FIG. 7 is a cross sectional view showing the fuel cell, taken along a line VII-VII in FIG. 6;

FIG. 8 is an exploded perspective view showing a fuel cell according to a second embodiment of the present invention;

FIG. 9 is a front view showing a separator of the fuel cell;

FIG. 10 is a cross sectional view schematically showing operation of the fuel cell;

FIG. 11 is a partial cross sectional view showing a fuel cell system according to a third embodiment of the present invention;

FIG. 12 is an exploded perspective view showing a fuel cell of the fuel cell system;

FIG. 13 is a cross sectional view schematically showing gas flows in the fuel cell;

FIG. 14 is an exploded perspective view showing a fuel cell according to a fourth embodiment of the present invention;

FIG. 15 is a front view showing a separator of the fuel cell;

FIG. 16 is a cross sectional view schematically showing operation of the fuel cell;

FIG. 17 is an exploded perspective view showing a fuel cell according to a fifth embodiment of the present invention;

FIG. 18 is a front view showing a separator of the fuel cell;

FIG. 19 is a cross sectional view schematically showing operation of the fuel cell;

FIG. 20 is an exploded perspective view showing a fuel cell according to a sixth embodiment of the present invention;

FIG. 21 is a front view showing a separator of the fuel cell;

FIG. 22 is a cross sectional view schematically showing operation of the fuel cell;

FIG. 23 is a cross sectional view showing the fuel cell, taken along a line XXIII-XXIII in FIG. 22; and

FIG. 24 is a view showing a conventional fuel cell.

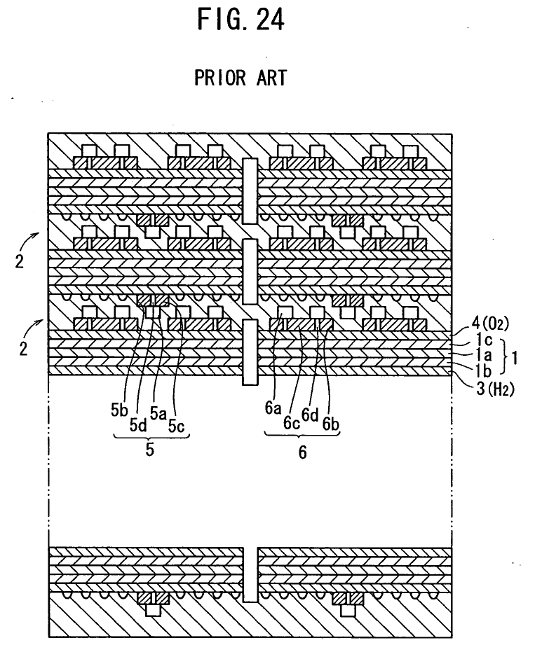

### DESCRIPTION OF THE PREFERRED EMBODIMENTS

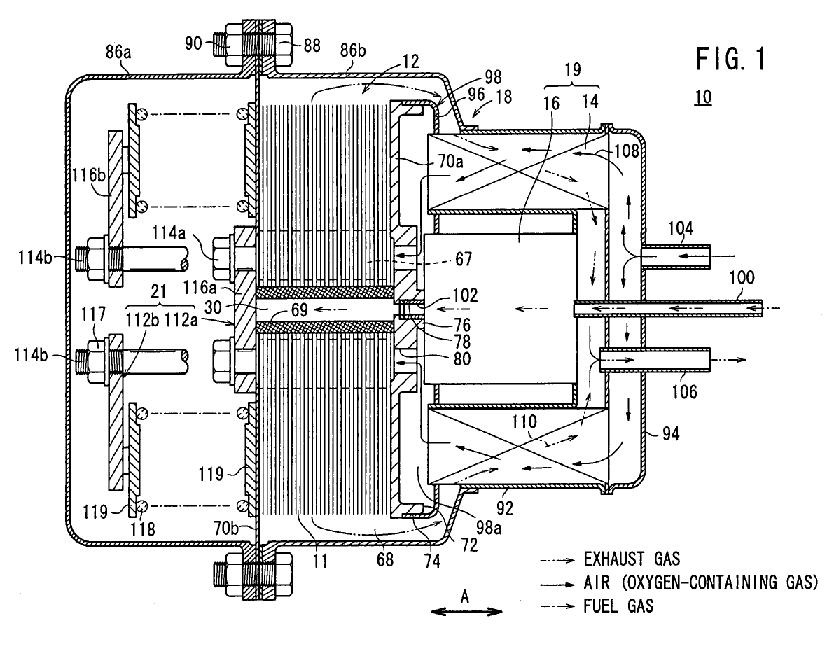

A fuel cell system 10 is used in various applications, including stationary and mobile applications. For example, the fuel cell system 10 is mounted on a vehicle. As shown in FIG. 1, the fuel cell system 10 includes a fuel cell stack 12, a heat exchanger 14, a reformer 16, and a casing 18. The fuel cell stack 12 is formed by stacking a plurality of fuel cells 11 in a direction indicated by an arrow A. The heat exchanger 14 heats an oxygen-containing gas before it is supplied to the fuel cell stack 12. The reformer 16 reforms a fuel to produce a fuel gas. The fuel cell stack 12, the heat exchanger 14, and the reformer 16 are disposed in the casing 18.

In the casing 18, a fluid unit 19 including at least the heat exchanger 14 and the reformer 16 is disposed on one side of the fuel cell stack 12, and a load applying mechanism 21 for applying a tightening load to the fuel cells 11 in the stacking direction indicated by the arrow A is disposed on the other side of the fuel cell stack 12. The fluid unit 19 and the load applying mechanism 21 are provided symmetrically with respect to the central axis of the fuel cell stack 12.

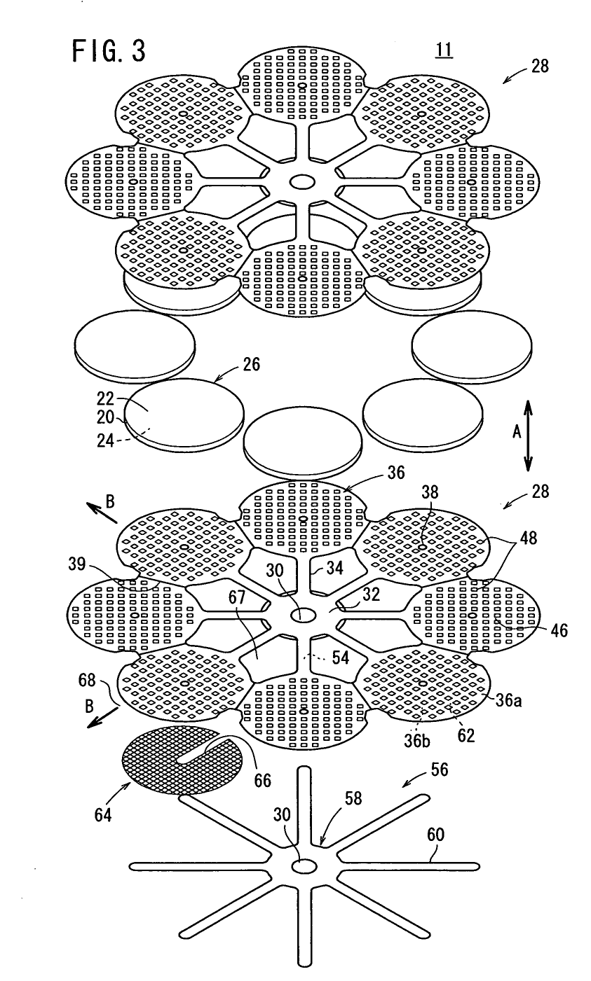

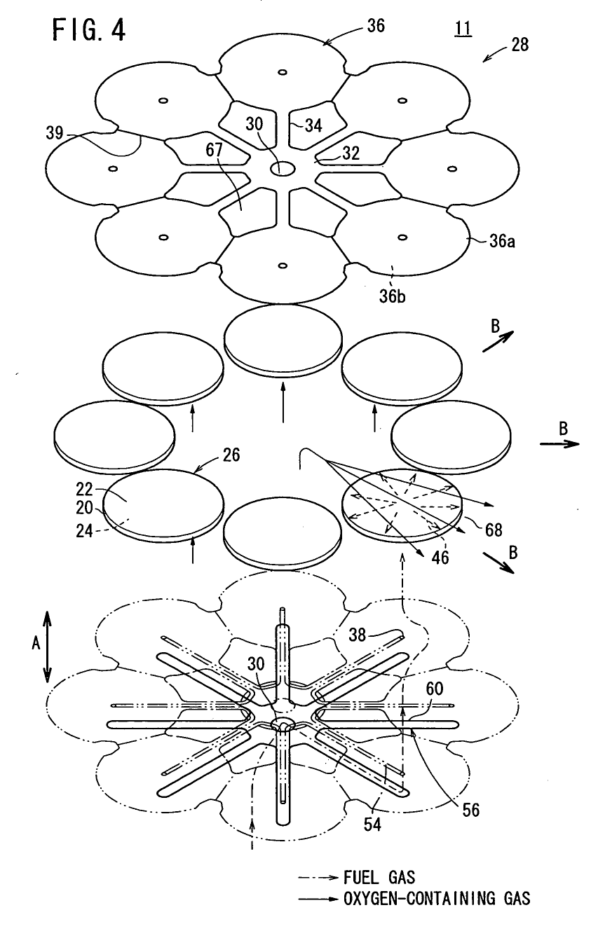

The fuel cell 11 is a solid oxide fuel cell (SOFC). As shown in FIGS. 3 and 4, the fuel cell 11 includes electrolyte electrode assemblies 26. Each of the electrolyte electrode assemblies 26 includes a cathode 22, an anode 24, and an electrolyte (electrolyte plate) 20 interposed between the cathode 22 and the anode 24. For example, the electrolyte 20 is made of ion-conductive solid oxide such as stabilized zirconia. The electrolyte electrode assembly 26 has a circular disk shape. A barrier layer (not shown) is provided at least at the inner circumferential edge of the electrolyte electrode assembly 26 (central side of the separator 28) for preventing the entry of the oxygen-containing gas.

A plurality of, e.g., eight electrolyte electrode assemblies 26 are sandwiched between a pair of separators 28 to form the fuel cell 11. The eight electrolyte electrode assemblies 26 are concentric with a fuel gas supply passage (fuel gas supply unit) 30 extending through the center of the separators 28.

In FIG. 3, for example, each of the separators 28 comprises a single metal plate. The separator 28 has a first small diameter end portion 32. The fuel gas supply passage 30 extends through the center of the first small diameter end portion 32. The first small diameter end portion 32 is integral with circular disks 36 each having a relatively large diameter through a plurality of first bridges 34. The first bridges 34 extend radially outwardly from the first small diameter end portion 32 at equal angles (intervals).

The circular disk 36 and the electrolyte electrode assembly 26 have substantially the same size. A fuel gas inlet 38 for supplying the fuel gas is formed at the center of the electrolyte electrode assembly 26, or at an upstream position deviated from the center of the electrolyte electrode assembly 26 in the flow direction of the oxygen-containing gas. The adjacent circular disks 36 are separated from each other by a cutout 39.

Each of the circular disks 36 has a plurality of protrusions 48 on its surface 36a which contacts the anode 24. The protrusions 48 form a fuel gas channel 46 for supplying the fuel gas along an electrode surface of the anode 24. For example, the protrusions 48 are solid portions formed by etching on the surface 36a. Various shapes such as a square shape, a circular shape, a triangular shape, or a rectangular shape can be adopted as the cross sectional shape of the protrusions 48. The positions or the density of the protrusions 48 can be changed arbitrarily depending on the flow state of the fuel gas or the like.

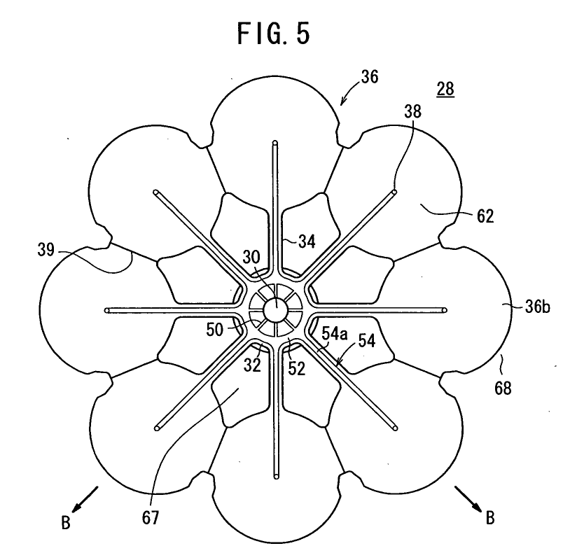

As shown in FIG. 5, each of the circular disks 36 has a substantially planar surface 36b which contacts the cathode 22. A plurality of slits 50 connected to the fuel gas supply passage 30 are radially formed in the first small diameter end portion 32. The slits 50 are connected to a recess 52. A groove 54a is formed in each of the first bridges 34. The groove 54a connects the fuel gas supply passage 30 to the fuel gas inlet 38 through the slit 50 and the recess 52. For example, the slit 50, the recess 52, and the groove 54a are fabricated by etching. The slit 50, the recess 52, and the groove 54a form a fuel gas supply channel 54.

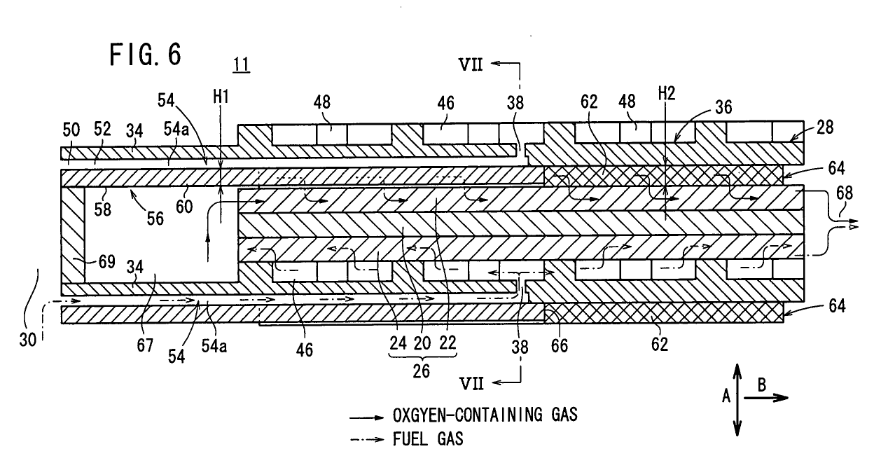

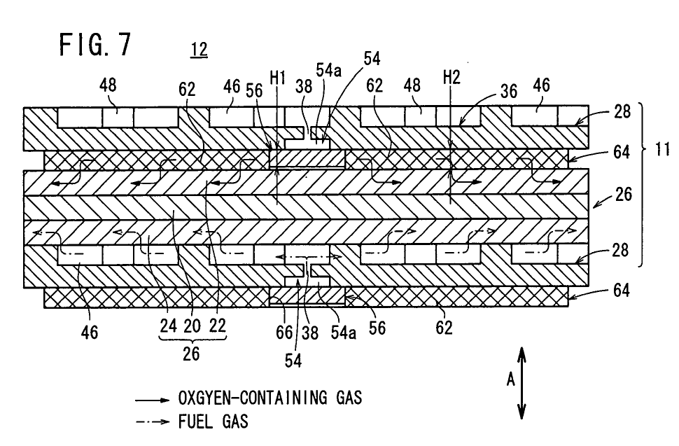

As shown in FIG. 3, a channel lid member 56 is fixed to a surface of the separator 28 facing the cathode 22, e.g., by brazing or laser welding or the like. The channel lid member 56 is a flat plate. A second small diameter end portion 58 is formed at the center of the channel lid member 56. The fuel gas supply passage 30 extends through the second small diameter end portion 58. Eight second bridges 60 extend radially from the second small diameter end portion 58. Each of the second bridges 60 is fixed to the separator 28, from the first bridge 34 to the surface 36b of the circular disk 36, covering the fuel gas inlet 38 (see FIGS. 6 and 7).

As shown in FIGS. 3 and 6, a deformable elastic channel member such as an electrically conductive mesh member 64 is provided on the surface 36b of the circular disk 36. The mesh member 64 forms an oxygen-containing gas channel 62 for supplying the oxygen-containing gas along an electrode surface of the cathode 22. The mesh member 64 tightly contacts the cathode 22. For example, the mesh member 64 is made of wire rod material of stainless steel (SUS material), and has a substantially circular disk shape.

The thickness of the mesh member 64 is determined such that the mesh member 64 is deformed elastically desirably when a load in the stacking direction indicated by the arrow A is applied to the mesh member 64. The mesh member 64 has a cutout 66 as a space for providing the second bridge 60 of the channel lid member 56. As shown in FIGS. 6 and 7, when the load in the stacking direction indicated by the arrow A is applied to the fuel cell 11, the height (thickness) H1 of the channel lid member 56 is smaller than the height H2 of the mesh member 64 in the stacking direction (H1≦H2).

As shown in FIG. 6, the area where the mesh member 64 is provided is smaller than the area where the protrusions 48 are provided on the surface 36a, i.e., smaller than the power generation area of the anode 24. The oxygen-containing gas channel 62 formed on the mesh member 64 is connected to the oxygen-containing gas supply unit 67. The oxygen-containing gas is supplied in the direction indicated by the arrow B through the space between the inner circumferential edge of the electrolyte electrode assembly 26 and the inner circumferential edge of the circular disk 36. The oxygen-containing gas supply unit 67 extends inside the respective circular disks 36 between the first bridges 34 in the stacking direction.

Insulating seals 69 for sealing the fuel gas supply passage 30 are provided between the separators 28. For example, the insulating seals 69 are made of mica material, or ceramic material. An exhaust gas channel 68 of the fuel cells 11 is formed outside the circular disks 36.

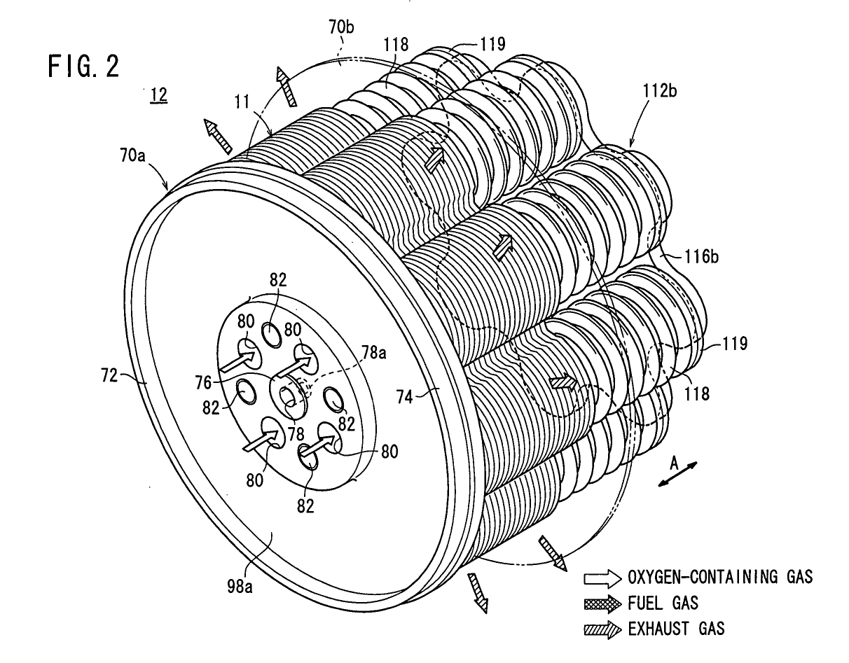

As shown in FIGS. 1 and 2, the fuel cell stack 12 includes end plates 70a, 70b provided at opposite ends of the fuel cells 11 in the stacking direction. The end plate 70a has a substantially circular disk shape. A ring shaped portion 72 protrudes from the outer circumferential end of the end plate 70a, and a groove 74 is formed around the ring shaped portion 72. A columnar projection 76 is formed at the center of the ring shaped portion 72. The columnar projection 76 protrudes in the same direction as the ring shaped portion 72. A stepped hole 78 is formed at the center in the projection 76.

Holes 80 and screw holes 82 are formed in the same virtual circle around the projection 76. The holes 80 and the screw holes 82 are arranged alternately, and spaced at predetermined angles (intervals), at positions corresponding to the respective spaces of the oxygen-containing gas supply unit 67 formed between the first and second bridges 34, 60. The diameter of the end plate 70b is larger than the diameter of the end plate 70a. The end plate 70a is an electrically conductive thin plate.

The casing 18 includes a first case unit 86a containing the load applying mechanism 21 and a second case unit 86b containing the fuel cell stack 12. The end plate 70b and an insulating member are sandwiched between the first case unit 86a and the second case unit 86b. The insulating member is provided on the side of the second case unit 86b. The joint portion between the first case unit 86a and the second case unit 86b is tightened by screws 88 and nuts 90. The end plate 70b functions as a gas barrier for preventing entry of the hot exhaust gas or the hot air from the fluid unit 19 into the load applying mechanism 21.

An end of a ring shaped wall plate 92 is joined to the second case unit 86b, and a head plate 94 is fixed to the other end of the wall plate 92. The fluid unit 19 is provided symmetrically with respect to the central axis of the fuel cell stack 12. Specifically, the substantially cylindrical reformer 16 is provided coaxially inside the substantially ring shaped heat exchanger 14.

A wall plate 96 is fixed to the groove 74 around the end plate 70a to form a channel member 98. The heat exchanger 14 and the reformer 16 are directly connected to the channel member 98. A chamber 98a is formed in the channel member 98, and the air heated at the heat exchanger 14 temporally fills the chamber 98a. The holes 80 are openings for supplying the air temporally filling in the chamber 98a to the fuel cell stack 12.

A fuel gas supply pipe 100 and a reformed gas supply pipe 102 are connected to the reformer 16. The fuel gas supply pipe 100 extends to the outside from the head plate 94. The reformed gas supply pipe 102 is inserted into the stepped hole 78 of the end plate 70a, and connected to the fuel gas supply passage 30.

An air supply pipe 104 and an exhaust gas pipe 106 are connected to the head plate 94. A channel 108 extending from the air supply pipe 104, and directly opened to the channel member 98 through the heat exchanger 14, and a channel 110 extending from the exhaust gas channel 68 of the fuel cell stack 12 to the exhaust gas pipe 106 through the heat exchanger 14 are provided in the casing 18.

The load applying mechanism 21 includes a first tightening unit 112a for applying a first tightening load T1 to a region around (near) the fuel gas supply passage 30 and a second tightening unit 112b for applying a second tightening load T2 to the electrolyte electrode assemblies 26. The second tightening load T2 is smaller than the first tightening load T1 (T1>T2).

The first tightening unit 112a includes short first tightening bolts 114a screwed into the screw holes 82 formed along one diagonal line of the end plate 70a. The first tightening bolts 114a extend in the stacking direction of the fuel cells 11, and engage a first presser plate 116a. The first tightening bolts 114a are provided in the oxygen-containing gas supply unit 67 extending through the separators 28. The first presser plate 116a is a narrow plate, and engages the central position of the separator 28 to cover the fuel gas supply passage 30.

The second tightening unit 112b includes long second tightening bolts 114b screwed into screw holes 82 formed along the other diagonal line of the end plate 70a. Ends of the second tightening bolts 114b extend through a second presser plate 116b having a curved outer section. Nuts 117 are fitted to the ends of the second tightening bolts 114b. The second tightening bolts 114b are provided in the oxygen-containing gas supply unit 67 extending through the separators 28. Springs 118 and spring seats 119 are provided in respective circular portions of the second presser plate 116b, at positions corresponding to the electrolyte electrode assemblies 26 on the circular disks 36 of the fuel cell 11. For example, the springs 118 are ceramics springs.

Next, operation of the fuel cell system 10 will be described below.

As shown in FIG. 3, in assembling the fuel cell system 10, firstly, the channel lid member 56 is joined to the surface of the separator 28 facing the cathode 22. Thus, the fuel gas supply channel 54 connected to the fuel gas supply passage 30 is formed between the separator 28 and the channel lid member 56. The fuel gas supply channel 54 is connected to the fuel gas channel 46 through the fuel gas inlet 38 (see FIGS. 6 and 7). The ring shaped insulating seal 69 is provided on each of the separators 28 around the fuel gas supply passage 30, and the mesh member 64 is provided between the separator 28 and the cathode 22.

In this manner, the separator 28 is fabricated. The eight electrolyte electrode assemblies 26 are interposed between a pair of the separators 28 to form the fuel cell 11. As shown in FIGS. 3 and 4, the electrolyte electrode assemblies 26 are interposed between the surface 36a of one separator 28 and the surface 36b of the other separator 28. The fuel gas inlet 38 is positioned at substantially the center in each of the anodes 24.

A plurality of the fuel cells 11 are stacked in the direction indicated by the arrow A, and the end plates 70a, 70b are provided at opposite ends in the stacking direction. As shown in FIGS. 1 and 2, on the endplate 70b side, the first presser plate 116a of the first tightening unit 112a is provided at a position corresponding to the center of the fuel cell 11.

In this state, the short first tightening bolts 114a are inserted through the first presser plate 116a and the end plate 70b toward the end plate 70a. Tip ends of the first tightening bolts 114a are screwed into, and fitted to the screw holes 82 formed along one of the diagonal lines of the end plate 70a. The heads of the first tightening bolts 114a engage the first presser plate 116a. The first tightening bolts 114a are rotated in the screw holes 82 to adjust the surface pressure of the first presser plate 116a. In this manner, in the fuel cell stack 12, the first tightening load T1 is applied to the region near the fuel gas supply passage 30.

Then, the springs 118 and the spring seats 119 are aligned axially with the electrolyte electrode assemblies 26 at respective positions of the circular disks 36. The second presser plate 116b of the second tightening unit 112b engages the spring seats 119 provided at one end of the springs 118.

Then, the long second tightening bolts 114b are inserted through the second presser plate 116b and the end plate 70b toward the end plate 70a. The tip end of the second tightening bolts 114b are screwed into, and fitted to the screw holes 82 formed along the other diagonal line of the end plate 70a. The nuts 117 are fitted to the heads of the second tightening bolts 114b. Therefore, by adjusting the state of the screw engagement between the nuts 117 and the second tightening bolts 114b, the second tightening load T2 is applied to the electrolyte electrode assemblies 26 by the elastic force of the respective springs 118.

The end plate 70b of the fuel cell stack 12 is sandwiched between the first case unit 86a and the second case unit 86b of the casing 18. The first case unit 86a and the second case unit 86b are fixed together by the screws 88 and the nuts 90. The fluid unit 19 is mounted in the second case unit 86b. The wall plate 96 of the fluid unit 19 is attached to the groove 74 around the end plate 70a. Thus, the channel member 98 is formed between the end plate 70a and the wall plate 96.

Next, in the fuel cell system 10, as shown in FIG. 1, a fuel (methane, ethane, propane, or the like) and, as necessary, water are supplied from the fuel gas supply pipe 100, and an oxygen-containing gas (hereinafter referred to as the “air”) is supplied from the air supply pipe 104.

The fuel is reformed when it passes through the reformer 16 to produce a fuel gas (hydrogen-containing gas). The fuel gas is supplied to the fuel gas supply passage 30 of the fuel cell stack 12. The fuel gas moves in the stacking direction indicated by the arrow A, and flows into the fuel gas supply channel 54 through the slits 50 and the recess 52 in the separator 28 of each fuel cell 11 (see FIG. 6).

The fuel gas flows along the fuel gas supply channel 54 between the first and second bridges 34, 60, and flows into the fuel gas channel 46 formed by the protrusions 48 from the fuel gas inlets 38 of the circular disks 36. The fuel gas inlets 38 are formed at positions corresponding to central regions of the anodes 24 of the electrolyte electrode assemblies 26. Thus, the fuel gas is supplied to from the fuel gas inlets 38 to the substantially central positions of the anodes 24, and flows outwardly from the central regions of the anodes 24 along the fuel gas channel 46.

As shown in FIG. 1, the air from the air supply pipe 104 flows through the channel 108 of the heat exchanger 14, and temporarily flows into the chamber 98a. The air flows through the holes 80 connected to the chamber 98a, and is supplied to the oxygen-containing gas supply unit 67 provided at substantially the center of the fuel cells 11. At this time, in the heat exchanger 14, as described later, since the exhaust gas discharged to the exhaust gas channel 68 flows through the channel 110, heat exchange between the air before supplied to the fuel cells 11 and the exhaust gas is performed. Therefore, the air is heated to a desired fuel cell operating temperature beforehand.

The oxygen-containing gas supplied to the oxygen-containing gas supply unit 67 flows into the space between the inner circumferential edge of the electrolyte electrode assembly 26 and the inner circumferential edge of the circular disk 36 in the direction indicated by the arrow B, and flows toward the oxygen-containing gas channel 62 formed by the mesh member 64. As shown in FIG. 6, in the oxygen-containing gas channel 62, the oxygen-containing gas flows from the inner circumferential edge (central region of the separator 28) to the outer circumferential edge (outer region of the separator 28) of, i.e., from one end to the other end of the outer circumferential region of the cathode 22 of the electrolyte electrode assembly 26.

Thus, in the electrolyte electrode assembly 26, the fuel gas flows from the central region to the outer circumferential region of the anode 24, and the oxygen-containing gas flows in one direction indicted by the arrow B on the electrode surface of the cathode 22. At this time, oxygen ions flow through the electrolyte 20 toward the anode 24 for generating electricity by electrochemical reactions.

The exhaust gas discharged to the outside of the respective electrolyte electrode assemblies 26 flows through the exhaust gas channel 68 in the stacking direction. When the exhaust gas flows through the channel 110 of the heat exchanger 14, heat exchange between the exhaust gas and the air is carried out. Then, the exhaust gas is discharged into the exhaust gas pipe 106.

In the first embodiment, as shown in FIGS. 6 and 7, the fuel gas channel 46 is formed on one surface 36a of the separator 28, and the oxygen-containing gas channel 62 is formed on the other surface 36b of the separator 28. The groove 54a connected to the fuel gas supply passage 30 and the fuel gas inlet 38 is formed on the surface 36b of the separator 28, and the channel lid member 56 forming the fuel gas supply channel 54 is provided on the surface 36b to cover the groove 54a.

It is sufficient that only the groove 54a is formed in the separator 28. Therefore, the thickness of the separator 28 is reduced significantly. Further, the groove 54a can be fabricated by etching or the like to have the accurate cross sectional shape. In the fuel cell 11 including the electrolyte electrode assemblies 26 and the pair of separators 28 sandwiching the electrolyte electrode assemblies 26, the dimension of the fuel cell 11 in the stacking direction is reduced significantly.

Further, the structure of the separator 28 is simplified greatly, and reduction in the production cost of the separator 28 is achieved. Thus, the fuel cell 11 can be fabricated economically as a whole.

The anode 24 of the electrolyte electrode assembly 26 contacts the protrusions 48 on the circular disk 36. The cathode 22 of the electrolyte electrode assembly 26 contacts the mesh member 64. In this state, the load in the stacking direction indicated by the arrow A is applied to the components of the fuel cell 11. Since the mesh member 64 is deformable, the mesh member 64 tightly contacts the cathode 22.

In the structure, the dimensional errors or distortions that occur at the time of production in the electrolyte electrode assembly 26 or the separator 28 can suitably be absorbed by elastic deformation of the mesh member 64. Thus, in the first embodiment, damage at the time of stacking the components of the fuel cell 11 is prevented. Since the components of the fuel cell 11 contact each other at many points, improvement in the performance of collecting electricity from the fuel cell 11 is achieved.

Further, when the load in the stacking direction indicated by the arrow A is applied to the fuel cell 11, the height (thickness) H1 of the channel lid member 56 is smaller than the height H2 of the mesh member 64 in the stacking direction (H1≦H2). Therefore, the load in the stacking direction is not applied to the channel lid member 56, and the fuel gas supply channel 54 is not deformed. Accordingly, the fuel gas can be supplied to the anode 24 suitably. Further, in the case of supplying the fuel gas to the electrolyte electrode assemblies 26, since the fuel gas supply channel 54 is not deformed, and the fuel gas supply channel 54 is formed with the accurate cross sectional shape, the fuel gas is equally distributed to each of the electrolyte electrode assemblies 26, and the uniform power generation is achieved.

The load in the stacking direction is efficiently transmitted through the protrusions 48 on the circular disk 36. Therefore, the fuel cells 11 can be stacked together with a small load, and distortion in the electrolyte electrode assemblies 26 and the separators 28 is reduced. In particular, even in the case of using the electrolyte electrode assembly 26 with small strength, having the thin electrolyte 20 and the thin cathode 22 (so called anode supported cell type MEA), the stress applied to the electrolyte 20 and the cathode 22 is released by the mesh member 64, and reduction in the damage is achieved advantageously.

The protrusions 48 on the surface 36a of the circular disk 36 are formed by etching or the like as solid portions. Thus, the shape, the positions, and the density of the protrusions 48 can be changed arbitrarily and easily, e.g., depending on the flow state of the fuel gas economically, and the desired flow of the fuel gas is achieved. Further, since the protrusions 48 are formed as solid portions, the protrusions 48 are not deformed, and thus, the load is transmitted through the protrusions 48, and electricity is collected through the protrusions 48 efficiently.

Further, in the first embodiment, the fuel gas supply passage 30 is provided hermetically inside the oxygen-containing gas supply unit 67, and the fuel gas supply channel 54 is provided along the separator surface. Therefore, the fuel gas before consumption is heated by the hot oxygen-containing gas which has been heated by the heat exchange at the heat exchanger 14. Thus, improvement in the heat efficiency is achieved.

Further, the exhaust gas channel 68 is provided around the separators 28. Since the exhaust gas channel 68 is used as a heat-insulating layer, heat radiation from the separators 28 is prevented. Further, the fuel gas inlet 38 is provided at the center of the circular disk 36, or provided at an upstream position deviated from the center of the circular disk 36 in the flow direction of the oxygen-containing gas. Therefore, the fuel gas supplied from the fuel gas inlet 38 is diffused radially from the center of the anode 24 easily. Thus, the uniform reaction occurs smoothly, and improvement in the fuel utilization ratio is achieved.

Further, the area where the mesh member 64 is provided is smaller than the power generation area of the anode 24 (see FIG. 6). Therefore, even if the exhaust gas flows around to the anode 24 from the outside of the electrolyte electrode assembly 26, the power generation area is not present in the outer circumferential edge of the cathode 22 opposite to the outer circumferential edge of the anode 24. Thus, fuel consumption by the circulating current does not increase significantly, and a large electromotive force can be collected easily. Accordingly, the performance of collecting electricity is improved, and the fuel utilization ratio is achieved advantageously. Further, the present invention can be carried out simply by using the mesh member 64 as the elastic channel member. Thus, the structure of the present invention is simplified economically.

Further, the eight electrolyte electrode assemblies 26 are arranged along a virtual circle concentric with the separator 28. Thus, the overall size of the fuel cell 11 is small, and the influence of the heat distortion can be avoided.

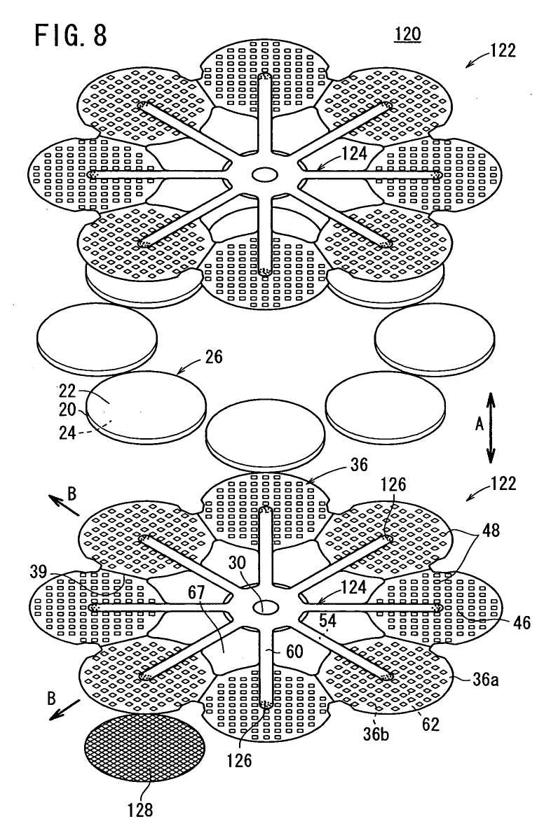

FIG. 8 is an exploded perspective view showing a fuel cell 120 according to a second embodiment of the present invention. The constituent elements that are identical to those of the fuel cell 11 according to the first embodiment are labeled with the same reference numeral, and description thereof will be omitted. In the third to sixth embodiments as described later, the constituent elements that are identical to those of the fuel cell 11 according to the first embodiment are labeled with the same reference numeral, and description thereof will be omitted.

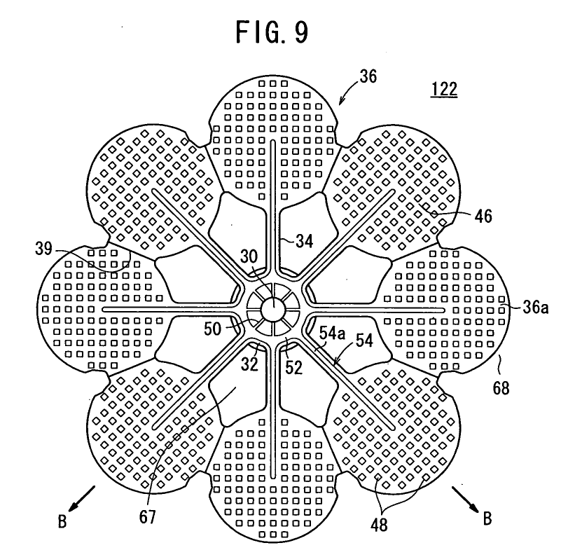

In the fuel cell 120, a channel lid member 124 is fixed to a surface of a separator 122 facing the anode 24. As shown in FIG. 9, slits 50, a recess 52, and grooves 54a are formed on a surface of the separator 122 facing the anode 24 by, e.g., etching.

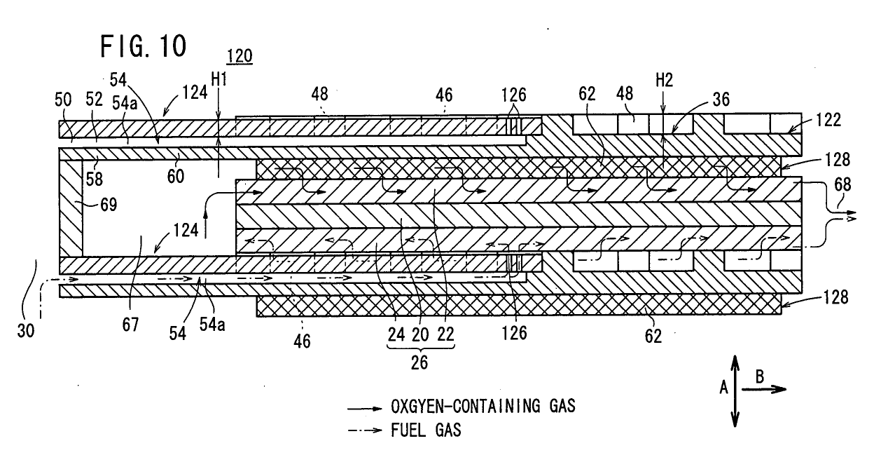

As shown in FIGS. 8 and 10, the channel lid member 124 has a planar shape, and a plurality of fuel gas inlets 126 are formed at the front ends of the second bridges 60. The fuel gas inlets 126 are opened to the anode 24. As shown in FIG. 10, when a load in the stacking direction indicated by the arrow A in applied to the fuel cell 120, the height (thickness) H1 of the channel lid member 124 is smaller than the height H2 of the protrusions 48 in the stacking direction (H1≦H2).

An elastic channel member such as an electrically conductive mesh member 128 is provided on the surface 36b of the circular disk 36. The mesh member 128 has a circular disk shape. The cutout 66 of the mesh member 64 is not required for the mesh member 128, and no fuel gas inlets 38 are required in the circular disks 36.

In the second embodiment, the fuel gas supplied to the fuel gas supply passage 30 flows along the fuel gas supply channel 54 formed between the separators 122 and the channel lid member 124. Further, the fuel gas is supplied toward the anode 24 from the fuel gas inlets 126 formed at the front end of each of the second bridges 60 of the channel lid member 124.

The air flows from the oxygen-containing gas supply unit 67 to the oxygen-containing gas channel 62 formed in the mesh member 128 interposed between the cathode 22 and each of the circular disks 36. The air flows in the direction indicate by the arrow B, and is supplied to the cathode 22.

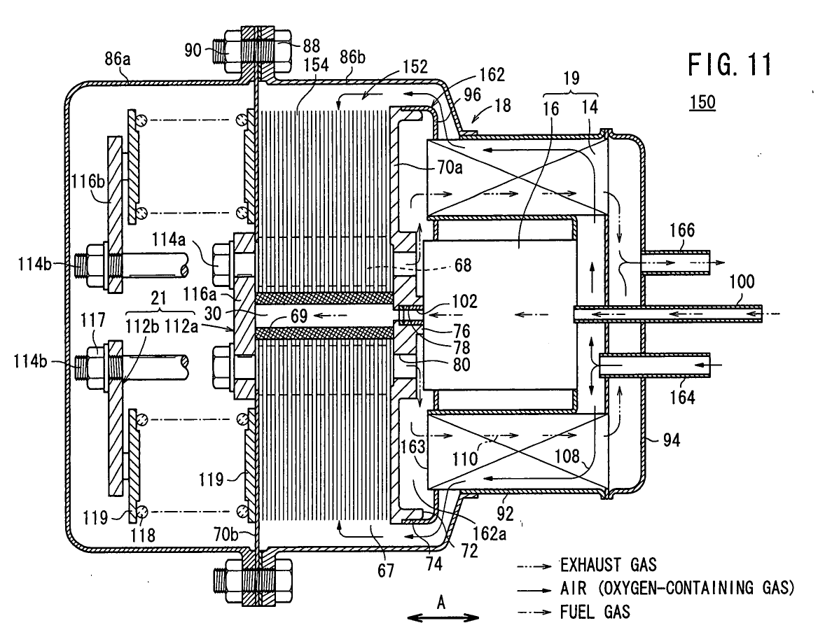

FIG. 11 is a cross sectional view showing a fuel cell system 150 according to a third embodiment of the present invention.

The fuel cell system 150 includes a fuel cell stack 152 provided in the casing 18. The fuel cell stack 152 is formed by stacking a plurality of fuel cells 154 in the direction indicated by the arrow A. The fuel cell stack 152 is sandwiched between the end plates 70a, 70b.

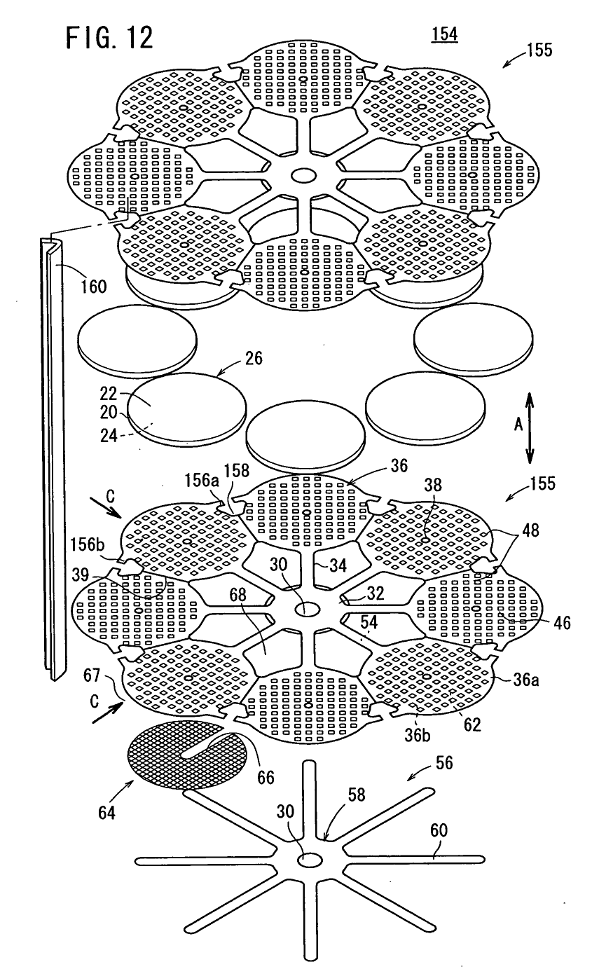

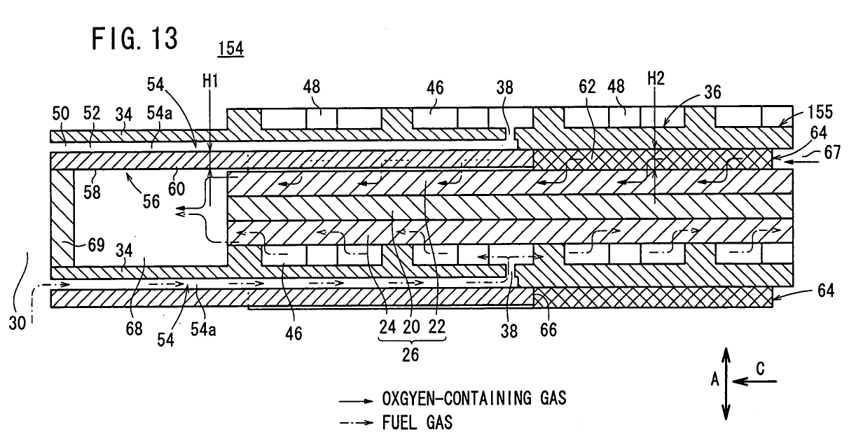

As shown in FIGS. 12 and 13, in the fuel cell 154, the oxygen-containing gas flows along the cathode 22 of the electrolyte electrode assembly 26 in the direction indicated by an arrow C from the outer circumferential edge to the inner circumferential edge of the cathode 22, i.e., in the direction opposite to the flow direction in the cases of the first and second embodiments.

In the separators 155 of the fuel cell 154, an oxygen-containing gas supply unit 67 is provided outside the circular disks 36. An exhaust gas channel 68 is formed by spaces between the first bridges 34 inside the circular disks 36 and the circle disks 36. The exhaust gas channel 68 extends in the stacking direction. Each of the circular disks 36 includes extensions 156a, 156b protruding toward the adjacent circular disks 36 on both sides, respectively. Spaces 158 are formed between the adjacent extensions 156a, 156b, and baffle plates 160 extend along the respective spaces 158 in the stacking direction.

As show in FIG. 13, the oxygen-containing gas channel 62 is connected to the oxygen-containing gas supply unit 67 for supplying the oxygen-containing gas from the space between the outer circumferential edge of the circular disk 36 and the outer circumferential edge of the electrolyte electrode assembly 26 in the direction indicated by the arrow C. The oxygen-containing gas supply unit 67 is formed around the separators 155 including the area outside the extensions 156a, 156b of the circular disks 36 (see FIG. 12).

As shown in FIG. 11, a channel member 162 having a chamber 162a connected to the exhaust gas channel 68 through the holes 80 is formed at the end plate 70a. The exhaust gas discharged from the fuel cells 154 temporarily fills in the chamber 162a. The exhaust gas flows through the channel 110 in the heat exchanger 14 through an opening 163 opened directly to the chamber 162a.

An air supply pipe 164 and an exhaust gas pipe 166 are connected to the head plate 94. The air supply pipe 164 extends up to a position near the reformer 16. An end of the exhaust gas pipe 166 is connected to the head plate 94.

In the third embodiment, the fuel gas flows from the fuel gas supply pipe 100 to the fuel gas supply passage 30 through the reformer 16. The air as the oxygen-containing gas flows from the air supply pipe 164 into the channel 108 of the heat exchanger 14, and is supplied to the oxygen-containing gas supply unit 67 outside the fuel cells 154. As shown in FIG. 13, the air flows from the spaces between the outer circumferential edge of the electrolyte electrode assembly 26 and the outer circumferential edge of the circular disk 36 in the direction indicated by the arrow C, and supplied to the oxygen-containing gas channel 62 formed by the mesh member 64.

Thus, power generation is performed in each of the electrolyte electrode assemblies 26. The exhaust gas as the mixture of the fuel gas and the air after consumption in the reactions of the power generation flows in the stacking direction through the exhaust gas channel 68 in the separators 155. The exhaust gas flows through the holes 80, and temporarily fills the chamber 162a in the channel member 162 formed at the end plate 70a (see FIG. 11). Further, when the exhaust gas flows through the channel 110 of the heat exchanger 14, heat exchange is performed between the exhaust gas and the air. Then, the exhaust gas is discharged into the exhaust gas pipe 166.

In the third embodiment, the fuel gas supply passage 30 is provided hermetically inside the exhaust gas channel 68, and the fuel gas supply channel 54 is provided along the separator surface. Therefore, the fuel gas flowing through the fuel gas supply passage 30 before consumption is heated by the heat of the exhaust gas discharged into the exhaust gas channel 68.

Further, since the exhaust gas channel 68 extends through the central part of the separators 155, it is possible to heat the separators 155 radially from the central part by the heat of the exhaust gas, and improvement in the heat efficiency is achieved.

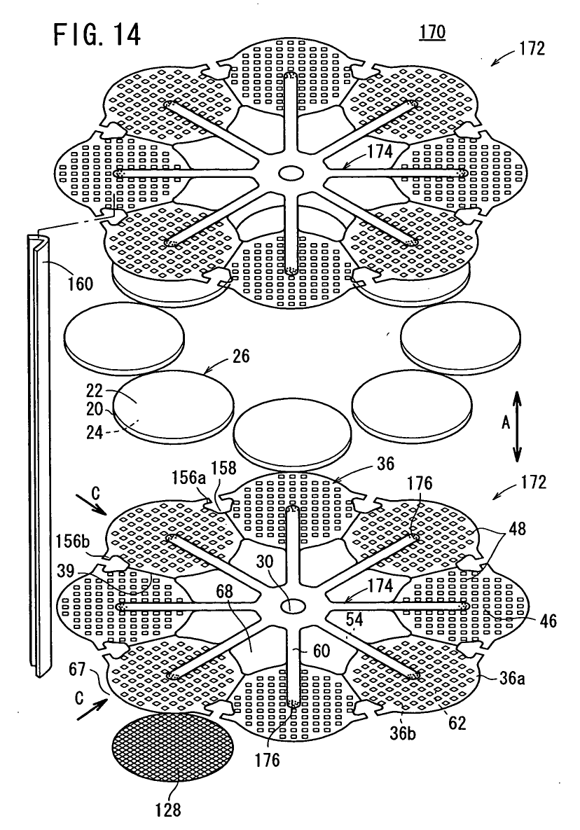

FIG. 14 is an exploded perspective view showing a fuel cell 170 according to a fourth embodiment of the present invention.

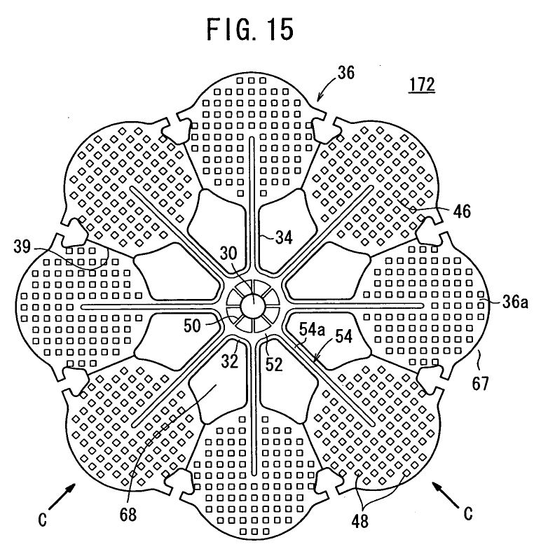

In the fuel cell 170, a channel lid member 174 is fixed to a surface of a separator 172 facing the anode 24. The channel lid member 174 has a flat shape. A plurality of fuel gas inlets 176 are formed at the front ends of the second bridges 60. The fuel gas inlets 176 are opened to the anode 24. As shown in FIG. 15, slits 50, a recess 52, and grooves 54a connected to the fuel gas supply passage 30 are formed on the surface 36a of the separator 172 by, e.g., etching.

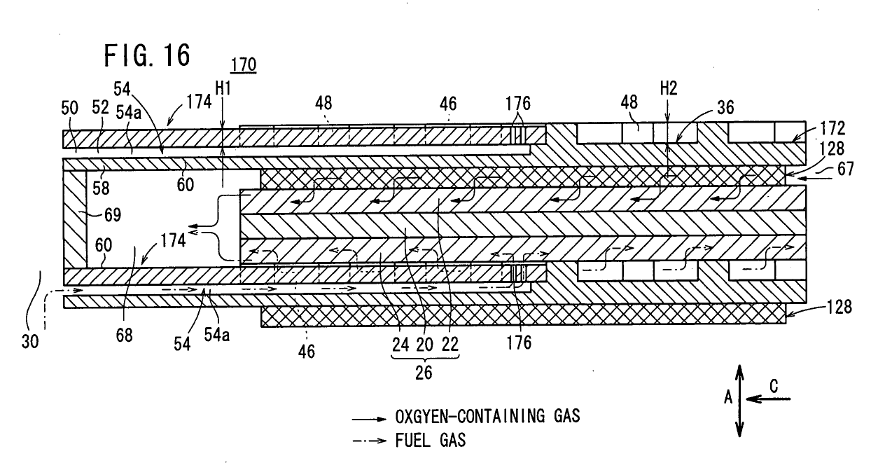

In the fourth embodiment having the above structure, the oxygen-containing gas, the fuel gas, and the exhaust gas flow as shown in FIG. 16.

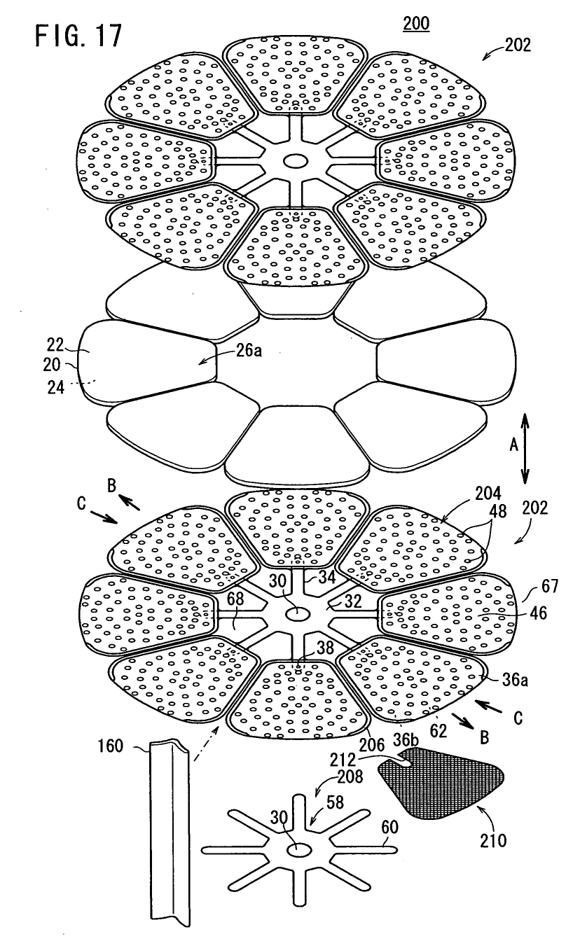

FIG. 17 is an exploded perspective view showing a fuel cell 200 according to a fifth embodiment of the present invention. The fuel cell 200 includes electrolyte electrode assemblies 26a having a substantially trapezoidal shape. Eight electrolyte electrode assemblies 26a are sandwiched between a pair of separators 202. The separator 202 includes trapezoidal sections 204 corresponding to the shape of the electrolyte electrode assemblies 26a. A plurality of protrusions 48 and a seal 206 are formed on a surface 36a of the trapezoidal section 204 facing the anode 24 by e.g., etching. The seal 206 is formed around the outer edge of the trapezoidal section 204, except the outer circumferential portion.

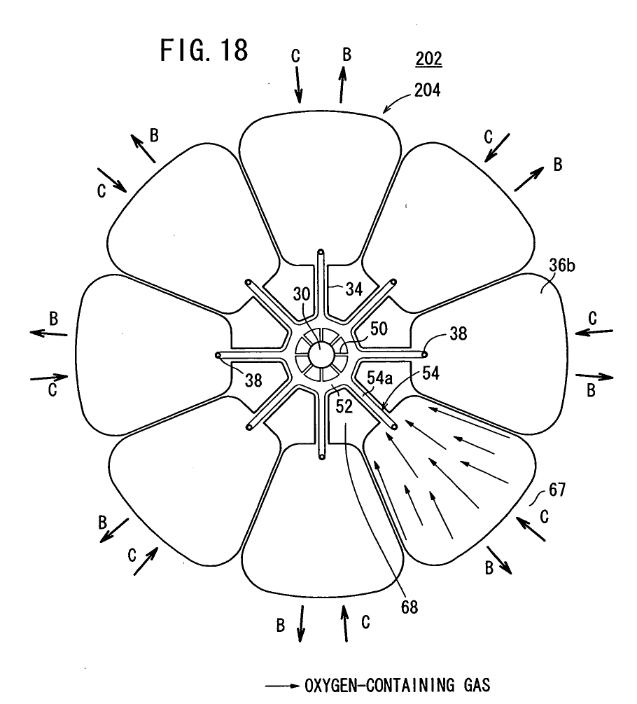

As shown in FIG. 18, slits 50, a recess 52, and a fuel gas supply channel 54 are formed on the surface 36b of the separator 202 by, e.g., etching. The fuel gas supply channel 54 is connected to a fuel gas inlet 38 formed at the inner edge portion of the trapezoidal section 204. A channel lid member 208 is fixed to the separator 202 to cover the slits 50, the recess 52, the grooves 54a, and the fuel gas inlets 38. The channel lid member 208 has a planar shape.

As shown in FIG. 17, a deformable elastic channel member such as an electrically conductive mesh member 210 is provided on the surface 36b of each of the trapezoidal sections 204. The mesh member 210 has a substantially trapezoidal shape, and has a cutout 212 as a space for providing the second bridge 60 of the channel lid member 208. The mesh member 210 has a substantially trapezoidal shape. The size of the mesh member 210 is smaller than the size of the trapezoidal section 204.

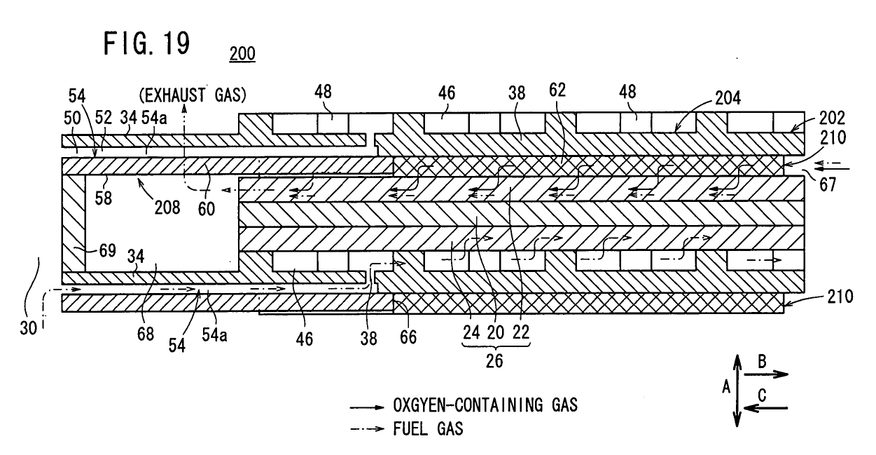

In the fifth embodiment, the fuel gas from the fuel gas supply passage 30 flows through the slit 50, the recess 52 of the separator 202 of the fuel cell 200, and flows into the groove 54a. As shown in FIG. 19, the fuel gas flows through the fuel gas supply channel 54. Then, the fuel gas flows through the fuel gas inlet 38 formed in the trapezoidal section 204, and is supplied to the fuel gas channel 46. Thus, the fuel gas flows outwardly in the direction indicated by the arrow B from the inner edge of the anode 24 toward the outer circumferential portion along the fuel gas channel 46.

The oxygen-containing gas supplied to the oxygen-containing gas supply unit 67 provided around the fuel cell 200 flows into the oxygen-containing gas channel 62 on the mesh member 210 from the space between the outer circumferential edge of the electrolyte electrode assembly 26a and the outer circumferential edge of the trapezoidal section 204 in the direction indicated by the arrow C. Thus, in the electrolyte electrode assembly 26a, electrochemical reactions are induced for power generation.

The fifth embodiment substantially adopts the structure of the third embodiment. However, the present invention is not limited in this respect. The fifth embodiment may adopt the structure of the fourth embodiment, or the structure of the first and second embodiments in which the oxygen-containing gas flows from the inside to the outside of the separators.

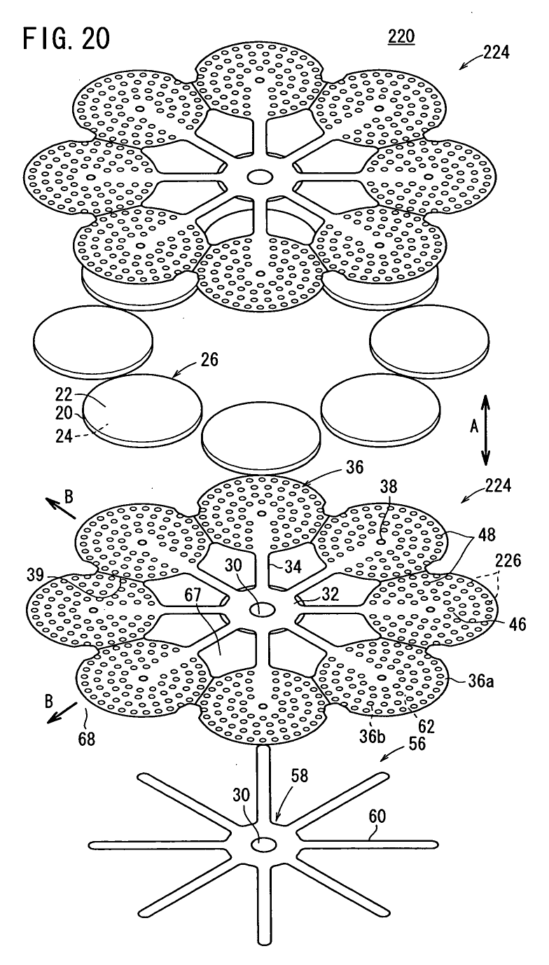

FIG. 20 is an exploded perspective view showing a fuel cell 220 according to a sixth embodiment of the present invention. A plurality of the fuel cells 220 are stacked together to form a fuel cell stack 222.

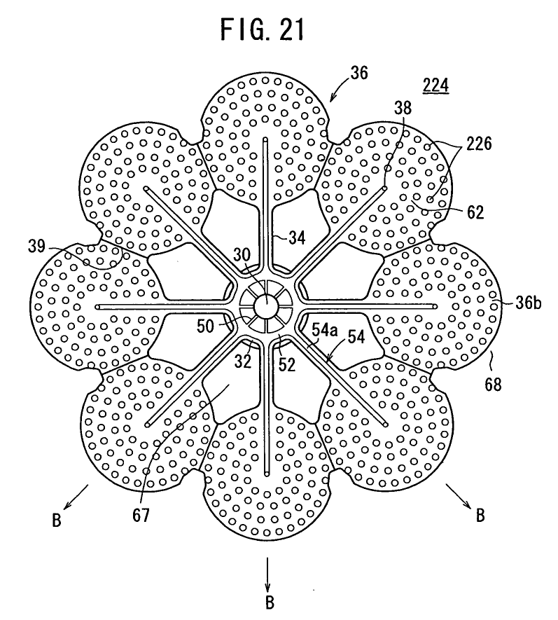

As shown in FIG. 21, each of circular disks 36 of the separator 224 of a fuel cell 220 has protrusions 226 on its surface which contacts the cathode 22. The protrusions 226 form an oxygen-containing gas channel 62 for supplying the oxygen-containing gas along an electrode surface of the cathode 22. The protrusions 226 are similar to the protrusions 48 formed on the surface 36a. The protrusions 226 are solid portions formed on the surface 36b by, e.g., etching.

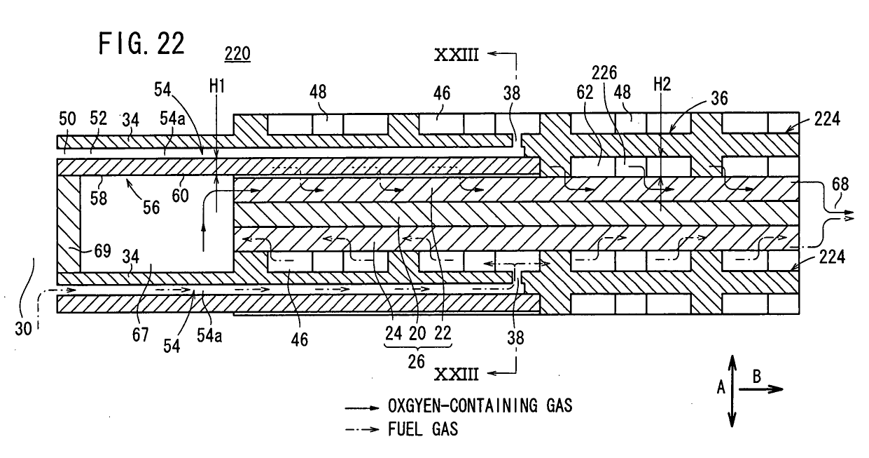

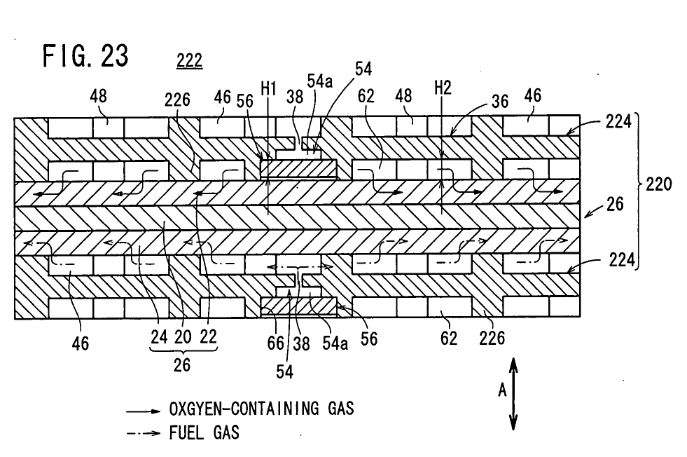

As shown in FIGS. 22 and 23, when a load in the stacking direction is applied to the fuel cell 220, the height (thickness) H1 of the channel lid member 56 is smaller than the height H2 of the protrusions 226 in the stacking direction (H1≦H2)

The fuel cell 220 according to the sixth embodiment has the same structure as the fuel cell 11 according to the first embodiment, except that the protrusions 226 are used instead of the mesh member 64. In the fuel cell 220, the oxygen-containing gas, the fuel gas, and the exhaust gas flow as shown in FIG. 22. The sixth embodiment may be modified in the same manner as in the case of the second to fifth embodiments, except that the protrusions 226 are used.

The invention has been particularly shown and described with reference to preferred embodiments, it will be understood that variations and modifications can be effected thereto by those skilled in the art without departing from the spirit and scope of the invention as defined by the appended claims.

What is claimed is:

1. A fuel cell including an electrolyte electrode assembly and a pair of separators sandwiching said electrolyte electrode assembly, said electrolyte electrode assembly including an anode, a cathode, and an electrolyte interposed between said anode and said cathode, said separators each comprising a single plate, said fuel cell comprising:
a fuel gas channel provided on one surface of said separator for supplying a fuel gas along an electrode surface of said anode;
an oxygen-containing gas channel provided on the other surface of said separator for supplying an oxygen-containing gas along an electrode surface of said cathode;
a groove formed on the one surface or on the other surface of said separator, and connected to a fuel gas supply unit and a fuel gas inlet for supplying the fuel gas into said fuel gas channel; and
a channel lid member provided on the one surface or on the other surface of said separator to cover said groove for forming a fuel gas supply channel.

2. A fuel cell according to claim 1, wherein protrusions forming said fuel gas channel are provided on one surface of said separator, and a deformable elastic channel unit forming said oxygen-containing gas channel and tightly contacting said cathode is provided on the other surface of said separator.

3. A fuel cell according to claim 2, wherein when a load in the stacking direction of said electrolyte electrode assembly and said separators is applied to said fuel cell, the height of said channel lid member is smaller than the height of said protrusions or said elastic channel unit in the stacking direction.

4. A fuel cell according to claim 1, further comprising an exhaust gas channel for discharging the fuel gas and the oxygen-containing gas consumed in the reaction in said electrolyte electrode assembly as an exhaust gas in the stacking direction of said electrolyte electrode assembly and said separators;
said fuel gas supply unit for supplying the fuel gas before consumption in the stacking direction is provided hermetically inside said exhaust gas channel; and
said fuel gas supply channel connects said fuel gas channel and said fuel gas supply unit, and is provided along the separator surface to intersect said exhaust gas channel extending in the stacking direction.

5. A fuel cell according to claim 4, wherein said exhaust gas channel is provided at the central region of said separators.

6. A fuel cell according to claim 5, wherein said fuel gas supply unit is provided hermetically at the center of said exhaust gas channel.

7. A fuel cell according to claim 1, wherein said fuel gas inlet is provided at the center of said electrolyte electrode assembly or at an upstream position deviated from the center of said electrolyte electrode assembly in the flow direction of the oxygen-containing gas.

8. A fuel cell according to claim 1, further comprising an oxygen-containing gas supply unit for supplying the oxygen-containing gas before consumption from the outer circumference of said electrolyte electrode assembly to said oxygen-containing gas supply channel.

9. A fuel cell according to claim 1, further comprising an exhaust gas channel for discharging the fuel gas and the oxygen-containing gas consumed in the reaction in said electrolyte electrode assembly as an exhaust gas in the stacking direction of said electrolyte electrode assembly and said separators; and
an oxygen-containing gas supply unit for allowing the oxygen-containing gas before consumption to flow in the stacking direction to supply the oxygen-containing gas to said oxygen-containing gas channel, wherein
said fuel gas supply unit for supplying the fuel gas before consumption in the stacking direction is provided hermetically inside said oxygen-containing gas supply unit; and
said fuel gas supply channel connects said fuel gas channel and said fuel gas supply unit, and is provided along the separator surface to intersect said oxygen-containing gas supply unit extending in the stacking direction.

10. A fuel cell according to claim 9, wherein said exhaust gas channel is provided around said separators.

11. A fuel cell according to claim 9, wherein said fuel gas supply unit is provided hermetically at the center of said separators.

12. A fuel cell according to claim 9, wherein said fuel gas inlet is provided at the center of said electrolyte electrode assembly or at an upstream position deviated from the center of said electrolyte electrode assembly in the flow direction of the oxygen-containing gas.

13. A fuel cell according to claim 9, further comprising an oxygen-containing gas supply unit for supplying the oxygen-containing gas before consumption from the inner circumferential surface of said electrolyte electrode assembly to said oxygen-containing gas supply channel.

14. A fuel cell according to claim 2, wherein an area where said elastic channel unit is provided is smaller than a power generation area of said anode.

15. A fuel cell according to claim 2, wherein said elastic channel unit is made of an electrically conductive metal mesh member.

16. A fuel cell according to claim 2, wherein said protrusions are solid portions formed on one surface of said separator by etching.

17. A fuel cell according to claim 1, wherein said electrolyte electrode assembly comprises a plurality of electrolyte electrode assemblies arranged along a virtual circle concentric with said separators.

18. A fuel cell stack formed by stacking a plurality of fuel cells, said fuel cells each including an electrolyte electrode assembly and a pair of separators sandwiching said electrolyte electrode assembly, said electrolyte electrode assembly including an anode, a cathode, and an electrolyte interposed between said anode and said cathode, said separators each comprising a single plate, said fuel cell comprising:
a fuel gas channel provided on one surface of said separator for supplying a fuel gas along an electrode surface of said anode;
an oxygen-containing gas channel provided on the other surface of said separator for supplying an oxygen-containing gas along an electrode surface of said cathode;
a groove formed on the one surface or on the other surface of said separator, and connected to a fuel gas supply unit and a fuel gas inlet for supplying the fuel gas into said fuel gas channel; and
a channel lid member provided on the one surface or on the other surface of said separator to cover said groove for forming a fuel gas supply channel.

19. A fuel cell stack according to claim 18, wherein protrusions forming said fuel gas channel are provided on one surface of said separator, and a deformable elastic channel unit forming said oxygen-containing gas channel and tightly contacting said cathode is provided on the other surface of said separator.

20. A fuel cell stack according to claim 19, wherein when a load in the stacking direction of said electrolyte electrode assembly and said separators is applied to said fuel cell, the height of said channel lid member is smaller than the height of said protrusions or said elastic channel unit in the stacking direction.
